(19) United States
(12) Patent Application Publication
(10) Pub. No.: US 2006/0218087 A1
(43) Pub. Date: Sep. 28, 2006

(54) Automated aggregation and comparison of individual spending relative to population of similar users

(76) Inventor: Jeffrey P. Zimmerman, Menlo Park, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/331,507

(22) Filed: Jan. 13, 2006

Related U.S. Application Data
(60) Provisional application No. 60/665,430, filed on Mar. 24, 2005.

(51) Int. Cl. G06Q 40/00

(52) U.S. Cl. 705/39

(57) ABSTRACT

A system and method compares a user's aggregated spending transactions with those of the population. The system and method aggregates the user's spending transactions, and compares with the corresponding population aggregated spending transactions.

### CROSS-REFERENCE TO RELATED PATENT APPLICATIONS

The present invention is related to U.S. Provisional Patent Application Ser. No. 60/665,430, for “Categorization Management,” filed Mar. 24, 2005, the disclosure of which is incorporated herein by reference.

The present invention is related to U.S. Utility patent application Ser. No. 11/148,959, for “Payee Aliasing,” filed Jun. 8, 2005, the disclosure of which is incorporated herein by reference.

The present invention is related to U.S. Utility patent application Ser. No. 11/073,396, for “Categorization of Financial Transactions,” filed Mar. 4, 2005, the disclosure of which is incorporated herein by reference.

### BACKGROUND

The present invention relates generally to systems and methods for comparing personal information with those of others in the area of personal finance. Most people are aware of their general spending, but do not know if they are over spending relative to others. Thus, it is desirable for a user to be able to compare his/her spending transactions with those of others in similar situations by category, by time period, and by other attributes such as payee.

One approach to allow users to compare their spending transactions with those of others is to provide them with the general population's average spending data. This approach is inadequate because individuals in different demographic or geographic segments of the society have different spending patterns, and comparison to the general public makes little sense in helping the users to spot over spending. This approach is also inadequate in that users cannot compare their spending by category to the general population, as the general population's average spending data do not provide categorized spending data.

Another approach is to provide users with access to a central database storing all users' spending transactions. Besides privacy concerns, this approach shares similar shortcomings as the approach above. Because the user's spending transactions do not include category information, the users cannot compare their spending by attributes such as category. Also, unless the users can limit the comparison to population with similar demographic and/or geographic segment, the result may not be helpful.

### SUMMARY

In various embodiments, the present invention provides methods and systems for comparing a user's spending transactions by category, payee, or other attributes to those of others in a demographic and/or geographic segment. The user's spending transactions is first aggregated by at least one attribute, such as category, to generate an aggregated spending amount. The aggregated spending amount is then compared to the aggregated spending amount of the population in the demographic and/or geographic segment.

In one embodiment, a central server maintains a central categorization mapping database storing a collection of payees and their corresponding categories. When the central server receives a user's spending transactions, it generates categorized spending transactions, aggregates the generated spending transactions by category into aggregated spending amounts, and saves the user's spending transactions. Based on selective criteria, the central server retrieves and aggregates spending transactions of members of the population meeting the criteria, and compares by category with the user's aggregated spending amounts. The central server then saves the comparison result, or makes the result available to the user (or other individuals) in the form of a report.

In another embodiment, users' spending transactions are aggregated locally in a client computer by generating aggregated spending amounts based on categorization mapping data downloaded from a central server. The aggregated spending amounts are then uploaded to the central server. The central server compares the received aggregated spending amounts with aggregated spending amount of others meeting selective criteria. The central server then saves the comparison result, or makes the result available to users (or other individuals) in the form of a report.

### BRIEF DESCRIPTION OF THE DRAWINGS

FIG. 1 is a block diagram depicting an architecture for a system for comparing a user's spending transactions to those of others according to one embodiment.

FIG. 2 is a flow diagram depicting a method for comparing a user's spending transactions by category with those of others according to one embodiment.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

The present invention is now described more fully with reference to the accompanying Figures. The present invention may be embodied in many different forms and should not be construed as limited to the embodiments set forth herein. Rather these embodiments are provided so that this disclosure will be complete and will fully convey principles of the invention to those of skilled in the art.

Embodiments of the present invention can be implemented in either a personal financial software package or an accounting software package. It can be implemented as a feature of a software package, or as a feature of a web-based application or website, or as a plug-in that can be installed and used in connection with an existing software application.

System Architecture

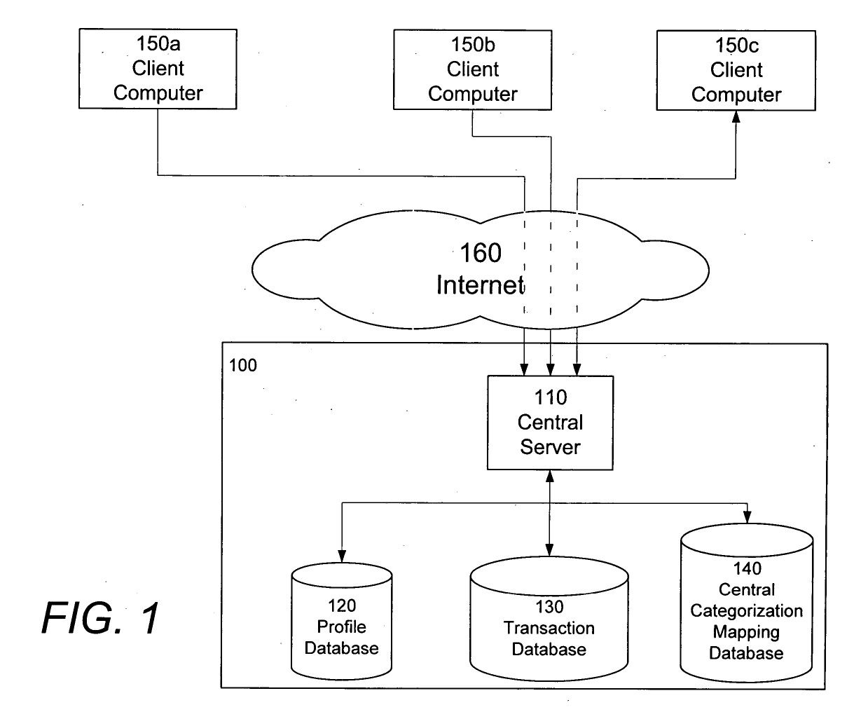

Referring to FIG. 1, there is shown a block diagram illustrating the architecture of one embodiment of a system 100 for comparing a user's spending transactions to population spending transactions. The system 100 includes a central server 110, a profile database 120, a transaction database 130, and a central categorization mapping database 140.

The central server 110 is connected to the profile database 120, the transaction database 130, and the central categorization mapping database 140. The central server 110 and the databases 120-140 can be in a single computer, or in separate computers communicating with each other through a network. The databases 120-140 may be a relational database or any other type of database that stores data used by the central server 110.

The system 100 is communicatively coupled to a network and client computers 150a, 150b, and 150c, as indicated by dotted lines. For illustrative purposes, FIG. 1 depicts the communications medium as the Internet 160, although one skilled in the art will recognize that other communications media such as local- or wide-area networks, or other types of networks, can be used.

The central server 110 and client computers 150a-c are of conventional design, and includes a processor, an addressable memory, and other conventional features such as a display, local memory, input/output ports, and a network interface. In other embodiments one or more of the components of the central server 110 and client computers 150a-c may be located remotely and accessed via a network.

One skilled in the art will recognize that the system architecture illustrated in FIG. 1 is merely exemplary, and that the invention may be practiced and implemented using many other architectures and environments.

Method

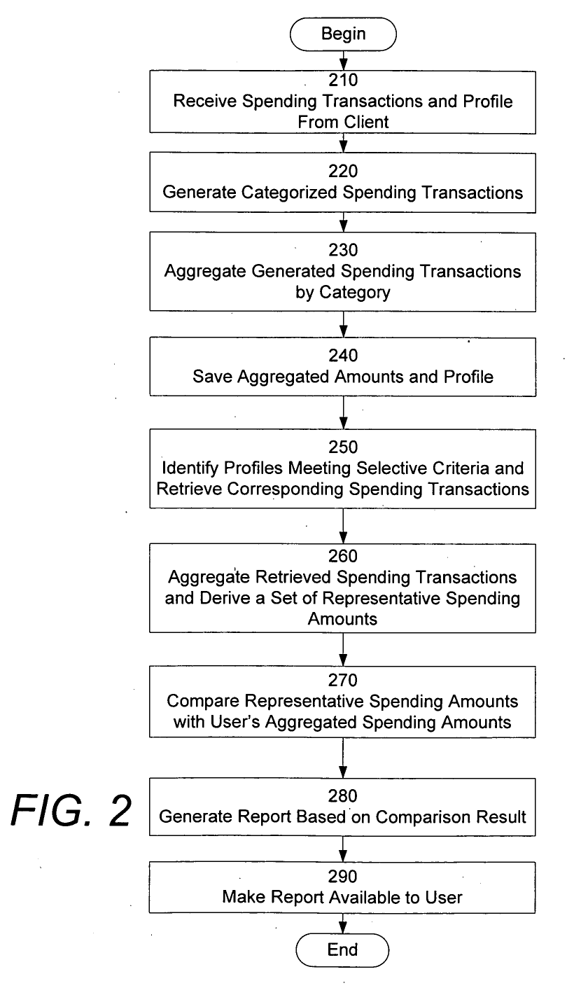

Referring now to FIG. 2, there is shown a flow diagram depicting a method for comparing a user's spending transactions by category with those of others as specified in selective criteria in accordance with one embodiment of the present invention. The steps of the process illustrated in FIG. 2 may be implemented in software, hardware, or a combination of hardware and software. In one embodiment, the steps of FIG. 2 may be performed by one or more components of the architecture shown in FIG. 1, although one skilled in the art will recognize that the method could be performed by systems having different architectures as well.

The central server 110 receives 210 a user's profile, spending transactions, selective criteria, and aggregative criteria from the client computer 150a. The client computer 150a sends such data to the central server 110 when the user requests a report comparing his/her spending transactions with those of others. Alternatively, in one embodiment, the client computer 150a sends the user's data automatically and periodically, such as monthly, or whenever the client computer 150a is connected to the Internet 160, or in response to some other trigger event(s). The ability to automatically and periodically receive users' spending transactions allows the user to compare his/her spending transactions with up-to-date spending transactions of others.

The profile data can include any type of data, including for example name, address, ZIP code, income, age, size of family, marital status, tax filing status, bank, and/or occupation. Such profile data can be uploaded each time the client computer 150a uploads data. Alternatively, in one embodiment, the profile data is only uploaded once, and subsequently uploaded data can include a profile ID in lieu of some or all of the profile data.

The spending transactions include payee information, date of transaction, amount of transaction, and the like. The table below illustrates some exemplary spending transactions.

| Payee | Date | Amount |
|---|---|---|
| Gap | Oct. 29, 2005 | $89.30 |
| Joy Luck Place | Oct. 30, 2005 | $31 |
| Cantankerous Fish | Oct. 29, 2005 | $67.16 |
| T-Mobile | Oct. 24, 2005 | $25.59 |
| Joy Luck Place | Oct. 21, 2005 | $24 |

Alternatively, the spending transactions can be already aggregated by time period, such as month of transaction before received 210 by the central server, as illustrated by the table below. This approach can alleviate users' privacy concerns and reduce network traffic.

| Payee | Month | Amount |
|---|---|---|
| Gap | October 2005 | $89.30 |
| Joy Luck Place | October 2005 | $55 |
| Cantankerous Fish | October 2005 | $67.16 |
| T-Mobile | October 2005 | $25.59 |

The optional selective criteria specify what demographic/geographic segment of the population to compare with. For example, a Silicon Valley resident might be compared with others living in the San Francisco Bay Area who are under 40 and married with children. Alternatively, the selective criteria can also limit the comparing group to be customers of a specific bank and/or by other criteria.

The optional aggregative criteria specify how the spending transactions should be aggregated. For example, it may be desirable to compare the user's spending by category with that of the population. Alternatively, the user may want to only aggregate on time and payee. For example, it may be desirable to compare the user's annual spending on GEICO insurance with that of the population.

The optional selective criteria and aggregative criteria can be set by the user as specified in his/her request for a report, by the client computer 150a, or by the central server 110 based (for example) on the user's previously used selective criteria and/or aggregative criteria.

When the aggregative criteria specify the spending transactions to be aggregated by category, the central server 110 generates 220 categorized spending transactions based on the central categorization mapping database 140. The central server 110 queries the central categorization mapping database 140, retrieves categories corresponding to the payees of the user's spending transactions, and generates 220 categorized spending transactions based on the received spending transactions and the retrieved categories.

When the user's spending transactions include payees not present in the central categorization mapping database 140, the central server 110 can prompt the user to provide such information, and add such payee-category information to the central categorization mapping database 140.

The table below illustrates the resultant exemplary categorized spending transactions.

| Payee | Category | Time | Amount |
|---|---|---|---|
| Gap | Merchandise | Oct. 29, 2005 | $89.30 |
| Joy Luck Place | Dining | Oct. 30, 2005 | $31 |
| Cantankerous Fish | Dining | Oct. 29, 2005 | $67.16 |
| T-Mobile | Services | Oct. 24, 2005 | $25.59 |
| Joy Luck Place | Dining | Oct. 21, 2005 | $24 |

The central server 110 aggregates 230 the spending transactions according to the aggregative criteria. The aggregative criteria include aggregation by time, by category, or by other attributes, such as payee. The table below illustrates the resultant exemplary data after aggregating 230 the categorized spending transactions by category.

| | Aggregated Spending |
|---|---|
| Category | Amount of October 2005 |
| Merchandise | $89.30 |
| Dining | $122.16 |
| Services | $25.59 |

In another embodiment, the aggregation 230 of the spending transactions is performed at the client computer 150a before the spending transactions is received 210. Such aggregation 230 can be by time, by payee, or by other attributes such as category.

When the spending transactions are aggregated by category, the client computer 150a stores a local categorization mapping database, generates categorized spending transactions based on the local categorization mapping database, and aggregates the categorized spending transactions by category in a process similar to the one for the central server 110 described above. The client computer 150a then uploads the aggregated spending amounts to the central server 110.

The local categorization mapping database can act as a persistent store of categorization mapping data that is periodically synchronized with the central categorization mapping database 140. Alternatively, in another embodiment, the local categorization mapping database can be used as a temporary local store of information downloaded from the central server 110 and kept only for a short period of time, such as during a current session.

The central server 110 saves 240 the user's profile in the profile database 120, and saves 240 the user's spending transactions in the transaction database 130. For privacy purposes, the central server 110 can be configured to save only the user's aggregated spending transactions, unless the user chooses otherwise. The central server 110 can also be configured to save the selective criteria and/or aggregative criteria.

The central server 110 identifies 250 profiles in the profile database 120 meeting the selective criteria, and retrieves spending transactions from the transaction database 130 corresponding to the qualified profiles.

For each qualified profile, the central server 110 aggregates 260 the corresponding retrieved spending transactions into aggregated spending amounts based on the aggregative criteria. The central server 110 then derives 260 a set of representative aggregated spending amounts from the aggregated spending amounts corresponding to all qualified profiles. The representative aggregated spending amounts can represent, for example, an average (a median, or a sum) of aggregated spending amounts corresponding to all qualified profiles. One skilled in the art will recognize that other forms of aggregation can be used for generating meaningful aggregated data for comparison purposes.

The central server 110 compares 270 the user's aggregated spending amounts with the representative aggregated spending amounts, generates 280 a report based on the comparison result, and then makes 290 the report available to the user and/or others.

Alternatively, the central server 110 compares 270 the user's aggregated spending amounts not only with the representative aggregated spending amounts, but also with the average spending amounts of the general population. The table below illustrates an example of a generated report based on such comparison.

| | Amount | Average of San Francisco | General |
|---|---|---|---|
| | for | Bay Area residents under | Average for |
| | November | 40 married with kids for | November |
| Category | 2005 | November 2005 | 2005 |
| Merchandise | $89.30 | $500.76 | $230.93 |
| Dining | $122.16 | $600.63 | $327.34 |
| Services | $25.59 | $230.03 | $102.68 |

Alternatively, the central server 110 compares 270 the user's aggregated spending amounts as percentages of the user's total spending to those of the population meeting the selective criteria. The table below illustrates an example of a generated report based on such comparison.

| | % of Total | Average of San Francisco Bay |
|---|---|---|
| | Spending in | Area AAA customers under 40 |
| Payee | 2005 | married with kids for 2005 |
| Gap | 3.12% | 2.51% |
| AAA | 4.16% | 5.63% |

Alternatively, the central server 110 can send comparison results to the client computer 150a, and the client computer 150a generates the report locally.

Alternatively, instead of making 290 the report available to the user, the central server 110 can save the report and/or the comparison result.

When the profile database 120 and the transaction database 130 are initially set up, there may not be enough spending transactions to conduct any meaningful comparisons. Thus, in one embodiment, the central server 110 uses general spending data to compare by category with users' financial data. Such general average data can include, for example, general spending data for each category.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those of skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method of comparing a user's spending transactions to population spending transactions, each spending transaction having a payee, a date, and an amount, the method comprising:
aggregating the user's spending transactions with respect to at least one attribute of the user's spending transactions to obtain an aggregated spending amount of the user;
determining a population aggregated spending amount corresponding to the user's aggregated spending amount, the population aggregated spending amount derived from spending transactions of members of the population and having attributes that correspond to the at least one attribute of the user's spending transactions; and
generating a comparison of the user's aggregated spending amount and the population aggregated spending amount.

2. The method of claim 1, further comprising saving the user's spending transactions persistently in a database.

3. The method of claim 1, wherein aggregating the user's spending transactions comprises aggregating the user's spending transactions based on time period.

4. The method of claim 1, wherein aggregating the user's spending transactions comprises:
generating categorized spending transactions based on the user's spending transactions and central categorization mapping data, the central categorization mapping data comprising payees and corresponding categories; and
aggregating the categorized spending transactions based on category.

5. The method of claim 1, further comprising receiving the user's data at a server, the server being geographically separated from the user, the user's data comprising the user's profile and the user's spending transactions.

6. The method of claim 5, wherein the user's data further comprise at least one selective criterion, and wherein determining a population aggregated spending amount comprises:
identifying qualified members of the population, each qualified member meeting the selective criterion; and
determining a population aggregated spending amount corresponding to the user's aggregated spending amount, the population aggregated spending amount derived from spending transactions of the qualified members and having attributes that correspond to the at least one attribute of the user's spending transactions.

7. The method of claim 6, wherein the selective criterion requires member's profile to match the user's profile, and wherein identifying qualified members of the population comprises:
identifying members with profiles matching the user's profile as the qualified members.

8. The method of claim 5, wherein receiving the user's data comprises periodically receiving the user's data.

9. The method of claim 8, wherein an identifier is associated with the user's profile, and wherein uploading the user's data comprises uploading the user's profile once and periodically uploading the user's spending transactions and the identifier.

10. A computer-implemented method of comparing a user's aggregated spending amount to corresponding population aggregated spending amount, the method comprising:
determining the corresponding population aggregated spending amount based on the user's aggregated spending amount and population spending transactions, each spending transaction having a payee, a date, and an amount; and
generating a comparison of the user's aggregated spending amount and the corresponding population aggregated spending amount.

11. The method of claim 10, further comprising receiving the user's data at a server, the server being geographically separated from the user, the user's data comprising the user's profile and the user's aggregated spending amount.

12. The method of claim 11, wherein the user's data further comprise at least one selective criterion and at least one aggregative criterion, and wherein determining the corresponding population aggregated spending amount comprises:
identifying qualified members of the population, each qualified member meeting the selective criterion; and
determining the corresponding population aggregated spending amount based on spending transactions of the qualified members and the aggregative criterion.

13. The method of claim 12, wherein the selective criterion comprises a qualification of member's profile based on the user's profile, and wherein identifying qualified members of the population comprises identifying qualified members based on the qualified members' profiles.

14. The method of claim 11, wherein receiving the user's data is performed periodically.

15. The method of claim 14, wherein an identifier is associated with the user's profile, and wherein uploading the user's data comprises uploading the user's profile once and uploading the user's aggregated spending amount and the identifier periodically.

16. The method of claim 10, further comprising saving the user's aggregated spending amount persistently in a database.

17. The method of claim 10, further comprising:
sending central categorization mapping data by a server, or portion thereof to a client computer, the central categorization mapping data comprising payees and corresponding categories, the server being geographically separated from the client computer, the sent central categorization mapping data being used to generate the user's aggregated spending amount; and
receiving the user's aggregated spending amount.

18. A system for comparing a user's spending transactions to population spending transactions, each spending transaction having a payee, a date, and an amount, comprising:
a processor for executing programs; and
a central server executable by the processor, the server including:
instructions for aggregating the user's spending transactions with respect to at least one attribute of the user's spending transactions to obtain an aggregated spending amount of the user;
instructions for determining a population aggregated spending amount corresponding to the user's aggregated spending amount, the population aggregated spending amount derived from spending transactions of members of the population and having attributes that correspond to the at least one attribute of the user's spending transactions; and
instructions for generating a comparison of the user's aggregated spending amount and the population aggregated spending amount.

19. A computer program product for use in conjunction with a computer system, the computer program product comprising a computer readable storage medium and a computer program mechanism embedded therein, the computer program mechanism including:
instructions for aggregating a user's spending transactions with respect to at least one attribute of the user's spending transactions to obtain an aggregated spending amount of the user;
instructions for determining a population aggregated spending amount corresponding to the user's aggregated spending amount, the population aggregated spending amount derived from spending transactions of members of the population and having attributes that correspond to the at least one attribute of the user's spending transactions; and
instructions for generating a comparison of the user's aggregated spending amount and the population aggregated spending amount.
